(19) United States
(12) Patent Application Publication
(10) Pub. No.: US 2008/0012951 A1
(43) Pub. Date: Jan. 17, 2008

(54) Photographing apparatus wirelessly transmitting image and method of controlling the same

(75) Inventor: Nam-hoon Paek, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/650,974

(22) Filed: Jan. 9, 2007

(30) Foreign Application Priority Data
Jul. 11, 2006 (KR) 2006-64882

(51) Int. Cl. H04N 5/232

(52) U.S. Cl. 348/211.2

(57) ABSTRACT

A photographing apparatus wirelessly transmitting an image and a method of controlling the photographing apparatus are provided, in which, a wireless transmitter wirelessly transmits an image to an external apparatus, and a controller controls the wireless transmitter to transmit to the external apparatus at least one of an image generated through photographing and an image pre-stored in a storage unit. Thus, an image, which is being photographed, can be stored and modulated, and transmitted to prevent the photographed image from disappearing. Also, the image can be stored, and another image can be displayed on an external apparatus to provide convenience to a user.

### CROSS-REFERENCE TO RELATED APPLICATIONS

This application claims the benefit under 35 U.S.C. § 119(a) of Korean Patent Application No. 10-2006-0064882, filed in the Korean Intellectual Property Office on Jul. 11, 2006, the entire disclosure of which is hereby incorporated by reference.

### BACKGROUND OF THE INVENTION

1. Field of the Invention

The present invention relates to a photographing apparatus wirelessly transmitting an image and a method of controlling the same. More particularly, the present invention relates to a photographing apparatus storing an image, which is being photographed, and wirelessly transmitting the photographed image or a pre-stored image and a method of controlling the same.

2. Description of the Related Art

Photographing apparatuses photograph subjects to generate images and store the images. Representative examples of the photographing apparatuses include digital cameras and digital camcorders. The photographing apparatuses may also replay stored images. Here, the replayed images may be displayed on televisions (TVs) connected to the photographing apparatuses.

There has been developed technology for wirelessly connecting photographing apparatuses to TVs to display images, which are being photographed, on external displays such as TVs. However, images, which are being photographed, are first stored and then wirelessly transmitted. Thus, users cannot quickly confirm the images which are being photographed.

Also, photographing apparatuses wirelessly transmitting images, which are being photographed, in real-time do not have the ability to store the images. Thus, if TVs are installed in places in which wireless systems cannot be installed, the users cannot confirm the images which are being photographed.

Accordingly, there is a need for an improved photographing apparatus and method for wirelessly transmitting images and storing images in real-time.

### SUMMARY OF THE INVENTION

An aspect of exemplary embodiments of the present invention address is to address at least the above problems and/or disadvantages and to provide at least the advantages described below. Accordingly, an aspect of exemplary embodiments of the present invention is to provide a photographing apparatus wirelessly transmitting an image to provide convenience to a user and a method of controlling the photographing apparatus.

Another aspect of exemplary embodiments of the present invention is to provide a photographing apparatus storing an image, which is being photographed, modulating the image, and transmitting the modulated image to prevent the photographed image from disappearing when the photographed image is not displayed on an external apparatus due to a transmission error and a method of controlling the photographing apparatus.

Another aspect of exemplary embodiments of the present invention is to provide a photographing apparatus storing an image, which is being photographed, and displaying a pre-stored second image on an external apparatus so that a user performs several works at a time and a method of controlling the photographing apparatus.

According to an aspect of exemplary embodiments of the present invention, there is provided a photographing apparatus including: a wireless transmitter wirelessly transmitting an image to an external apparatus; and a controller controlling the wireless transmitter to transmit at least one of an image generated through photographing and an image pre-stored in a storage unit to the external apparatus.

In an exemplary implementation, if a wirelessly transmitted image is the image generated through photographing, the controller may control the storage unit to store the image generated through photographing.

In another exemplary implementation, if a wirelessly transmitted image is the image pre-stored in the storage unit, the controller may control the storage unit to store the image generated through photographing.

According to another aspect of exemplary embodiments of the present invention, there is provided a method of controlling a photographing apparatus, in which, an image generated through photographing is stored; and the image generated through photographing is wirelessly transmitted to an external apparatus.

According to another aspect of exemplary embodiments of the present invention, there is provided a method of controlling a photographing apparatus, in which, an image generated through photographing is stored; and a pre-stored second image is wirelessly transmitted to an external apparatus.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1 is a block diagram of a digital camcorder according to an exemplary embodiment of the present invention; and

FIG. 2 is a flowchart of a method of storing and transmitting an image according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention will be described below in detail with reference to the accompanying drawings.

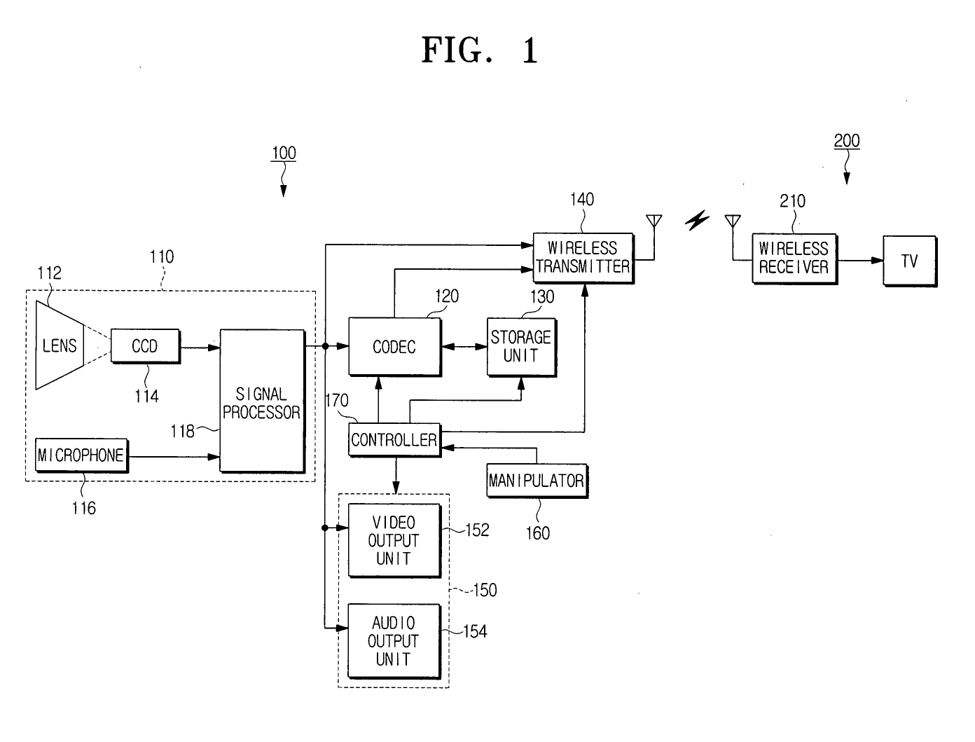

FIG. 1 is a block diagram of a digital camcorder 100 according to an exemplary embodiment of the present invention. Besides the digital camcorder 100, a television (TV) 200 including a wireless receiver 210 is further shown in FIG. 1. Referring to FIG. 1, the digital camcorder 100 according to an exemplary embodiment of the present invention includes an image photographing unit 110, a coder/decoder (CODEC) 120, a storage unit 130, a wireless transmitter 140, an image output unit 150, a manipulator 160, and a controller 170.

The image photographing unit 110 may include a lens 112, a charge-coupled device (CCD) 114, a microphone 116, and a signal processor 118.

The CCD 114 photographs an optical image of a subject incident through the lens 112 and generates a video signal corresponding to the photographed optical image. The digital camcorder 100 may include a complementary metal oxide semiconductor (CMOS) type instead of the CCD 114.

The signal processor 118 removes noise from the video signal output from the CCD 114, adjusts a level of the video signal, converts the video signal into a digital signal, and processes the digital signal. The signal processor 118 also amplifies an audio signal output from the microphone 116 and converts the audio signal into a digital signal.

The CODEC 120 may compress the video and audio signals (hereinafter referred to as image) processed by the signal processor 118 in a predetermined format and apply the compressed images to the storage unit 130. Alternatively, the CODEC 120 may decode an image output from the storage unit 130 into a re-playable original signal and apply the re-playable original signal to the wireless transmitter 140.

The storage unit 130 stores the images compressed by the CODEC 120. The storage unit 130 may pre-store other images. Here, the other images may be images photographed by the digital camcorder 100 shown in FIG. 1, images photographed by another photographing apparatus, or images transmitted and stored from an external apparatus. The storage unit 130 may also be integrated into the digital camcorder 100 or may be a recording medium attachable to and/or detachable from the digital camcorder 100.

The wireless transmitter 140 modulates the images output from the signal processor 118 or the CODEC 120 to wirelessly transmit the images and transmits the modulated images to the wireless receiver 210 through an antenna.

The image output unit 150 includes a video output unit 152 displaying the video signal and an audio output unit 154 outputting the audio signal. The video output unit 152 may be a liquid crystal display (LCD) or the like, and the audio output unit 154 may be a speaker or the like. The video output unit 152 may also display functions of the manipulator 160 which will be described later and be used as a part of the manipulator 160.

The manipulator 160 includes a selection button through which a mode of the digital camcorder 100 can be selected. A user may execute a photographing command or select an image the user desires to wirelessly transmit using the manipulator 160 including the selection button. Modes of the digital camcorder 100 related to an exemplary embodiment of the present invention are a photographing and photographed image transmitting mode and a photographing and second image transmitting mode. The photographing and photographed image transmitting mode refers to a mode in which a photographed image is stored and wirelessly transmitted to an external apparatus. The photographing and second image transmitting mode refers to a mode in which a photographed image is stored and a second image pre-stored in the storage unit 130 is wirelessly transmitted to an external apparatus.

The controller 170 controls an overall step of the digital camcorder 100. For example, if the user inputs the photographing and photographed image transmitting mode through the manipulator 160, the controller 170 controls the CODEC 120 to compress the images processed by the signal processor 118 and store the compressed images in the storage unit 130, and simultaneously controls the wireless transmitter 140 to modulate the images processed by the signal processor 118 to wirelessly transmit the images.

If the user inputs the photographing and second image transmitting mode through the manipulator 160, the controller 170 controls the CODEC 120 to compress the images processed by the signal processor and store the compressed images in the storage unit 130, and reads a second image pre-stored in the storage unit 130. The controller 170 also controls the CODEC 120 to decode the read second image and the wireless transmitter 140 to modulate the decoded second image to wirelessly transmit the decoded second image.

The controller 170 may control the image output unit 150 to output the images processed by the signal processor 118 and the video output unit 152 to display information regarding a manipulation command of the user input through the manipulator 160.

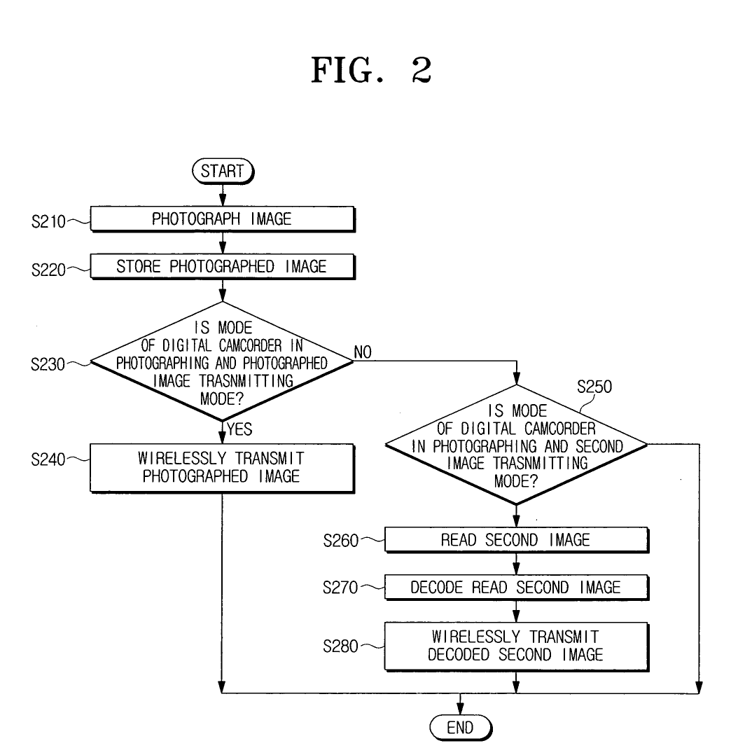

A method of wirelessly transmitting an image from the digital camcorder 100 illustrated in FIG. 1 will now be described with reference to FIG. 2.

FIG. 2 is a flowchart of a method of storing and wirelessly transmitting an image according to an exemplary embodiment of the present invention. Referring to FIG. 2, in step S210, the photographing unit 110 photographs an image. In detail, the CCD 114 photographs an optical image of a subject incident through the lens 112 and applies the photographed image to the signal processor 118, and the microphone 116 applies an audio to the signal processor 118. The signal processor 118 performs noise removal, analog-to-digital conversion (ADC), digital signal processing (DSP), and the like, on a video signal output from the CCD 114 and the signal processor 118, amplifies the audio signal output from the microphone 116, and converts the audio signals into digital signals.

In step S220, the controller 170 controls the storage unit 130 to store the photographed image. In detail, the controller 170 controls the CODEC 120 to compress the image output from the signal processor 118 and the storage unit 130 to store the compressed image.

In step S230, the controller 170 determines whether a mode of the digital camcorder 100 is in a photographing and photographed image transmitting mode. In other words, the controller 170 determines whether a user has inputted a command to select the mode of the digital camcorder 100 as the photographing and photographed image transmitting mode through the manipulator 160.

If it is determined in step S230 that the mode of the digital camcorder 100 is in the photographing and photographed image transmitting mode, the controller 170 controls the wireless transmitter 140 to modulate the photographed image to wirelessly transmit the photographed image in step S240. The modulated image is transmitted to the wireless receiver 210 through the antenna.

If it is determined in step S230 that the mode of the digital camcorder 100 is not in the photographing and photographed image transmitting mode, the controller 170 determines whether the mode of the digital camcorder 100 is in a photographing and second image transmitting mode in step S250.

If it is determined in step S250 that the mode of the digital camcorder 100 is the photographing and second image transmitting mode, the controller 170 reads the second image pre-stored in the storage unit 130 in step S260.

In step S270, the controller 170 controls the CODEC 120 to decode the read second image into an original re-playable image signal. In step S280, the controller 170 controls the wireless transmitter 140 to modulate the original re-playable image signal to wirelessly transmit the original re-playable image signal. The modulated image is transmitted to the wireless receiver 210 through the antenna.

Referring to FIG. 2, for convenience, it has been described that step S230 is performed after the photographed image is stored in the storage unit 130. Thus, step S230 is not limited to this case but may be performed before the image is photographed. Also, steps 230 and 250 may be performed in a reverse order. If the mode of the digital camcorder 100 is in the photographing and photographed image transmitting mode, processes of storing and transmitting the photographed image may be simultaneously performed. However, the processes are not limited to this case, but may be performed at predetermined time intervals a user can recognize.

If the digital camcorder 100 modulates a re-playable image signal and applies the modulated image signal to the wireless receiver 210, the wireless receiver 210 demodulates the modulated image signal into an original signal and applies the original signal to the TV 200. Here, it has been described with reference to FIG. 2 that a non-compressed image or a decompressed image is modulated and transmitted. However, a compressed image may be modulated and transmitted. In this case, the wireless receiver 210 may include an additional CODEC, and the TV 200 may directly decode the compressed image signal.

A method of storing and wirelessly transmitting a photographed image or second image has been described in detail in the exemplary embodiments of the present invention.

Exemplary embodiments of the present invention may be applied to a photographing apparatus photographing an image. In other words, exemplary embodiments of the present invention may be applied to a digital camcorder, a digital camera, a closed-circuit television (CCTV), a camera installed in a mobile phone, or other photographing apparatuses.

Exemplary embodiments of the present invention may also be applied to another display instead of a TV which displays a photographed image or a stored image.

As described above, according to exemplary embodiments of the present invention, an image can be wirelessly transmitted to provide convenience to a user. Also, an image, which is being photographed, can be stored and wirelessly transmitted to prevent the photographed image from disappearing due to a transmission error. In addition, the image, which is being photographed, can be stored, and a second image can be displayed on an external apparatus to provide convenience to a user.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A photographing apparatus comprising:
a wireless transmitter wirelessly transmitting an image to an external apparatus; and
a controller controlling the wireless transmitter to transmit at least one of an image generated through photographing and an image pre-stored in a storage unit to the external apparatus.

2. The photographing apparatus of claim 1, wherein if a wirelessly transmitted image comprises an image generated through photographing, the controller controls the storage unit to store the image generated through photographing.

3. The photographing apparatus of claim 1, wherein if a wirelessly transmitted image comprises an image pre-stored in the storage unit, the controller controls the storage unit to store the mage generated through photographing.

4. A method of controlling a photographing apparatus, the method comprising:
storing an image generated through photographing; and
wirelessly transmitting to an external apparatus at least one of the image generated through photographing and a pre-stored second image.

5. A method of controlling a photographing apparatus, the method comprising:
storing a compressed image generated through photographing and pre-storing a second image;
modulating the compressed image and pre-stored second image; and
wirelessly transmitting to an external apparatus the compressed image and the pre-stored second image.

6. The method of claim 5, further comprising selecting a mode of the photographing apparatus.

7. The method of claim 6, further comprising determining whether a command is input to select the mode of the photographing apparatus.

8. The method of claim 7, wherein if the mode of the photographing apparatus comprises a photographing and photographed image transmitting mode, compressing the images, storing the compressed images, and substantially simultaneously controlling a wireless transmitter to modulate the images to wirelessly transmit the images.

9. The method of claim 7, wherein if the mode of the photographing apparatus comprises a photographing and second image transmitting mode, compressing the images, storing the compressed images in the storage unit, reading and decoding the second image, and substantially simultaneously controlling a wireless transmitter to modulate the decoded second image to wirelessly transmit the decoded second image.

10. A photographing apparatus comprising:
an image photographing unit for photographing an optical image;
a coder/decoder (CODEC) for compressing video and audio signals processed by a signal processor;
a storage unit for storing images compressed by the CODEC and pre-storing a second image; and
a wireless transmitter for modulating the images output from at least one of the signal processor and the CODEC, and wirelessly transmitting the images and modulated images to a wireless receiver.

11. The photographing apparatus of claim 10, further comprising a manipulator comprising a selection button for selecting a mode of the photographing apparatus.

12. The photographing apparatus of claim 11, further comprising a controller for determining whether a command is input to select the mode of the photographing apparatus through the manipulator.

13. The photographing apparatus of claim 12, wherein the mode of the photographing apparatus comprises at least one of a photographing and photographed image transmitting mode, and a photographing and a second image transmitting mode.

14. The photographing apparatus of claim 13, wherein if the mode of the photographing apparatus comprises the photographing and photographed image transmitting mode, the controller controls the CODEC to compress the images processed by the signal processor, store the compressed images in the storage unit, and substantially simultaneously controls the wireless transmitter to modulate the images processed by the signal processor to wirelessly transmit the images.

15. The photographing apparatus of claim 13, wherein if the mode of the photographing apparatus comprises the photographing and second image transmitting mode, the controller controls the CODEC to compress the images processed by the signal processor, store the compressed images in the storage unit, read and decode the second image, and substantially simultaneously controls the wireless transmitter to modulate the decoded second image to wirelessly transmit the decoded second image.
